(19) United States
(12) Patent Application Publication
(10) Pub. No.: US 2012/0131994 A1
(43) Pub. Date: May 31, 2012

(54) RETAINER STRUCTURE FOR VEHICLE TESTING PLATFORM, USE OF THE RETAINER, AND SPECIALIZED VEHICLE TESTING PLATFORM TO TEST AN ELECTRONIC STABILITY PROGRAM OF A VEHICLE

(76) Inventor: Yona Ben-David, Ramat Efal (IL)

(21) Appl. No.: 13/052,138

(22) Filed: Mar. 21, 2011

Related U.S. Application Data
(63) Continuation-in-part of application No. 12/731,157, filed on Mar. 25, 2010, now abandoned.

(51) Int. Cl. G01M 17/00

(52) U.S. Cl. 73/116.01

(57) ABSTRACT

The invention pertains to a vehicle testing platform for testing the electronic stability program (ESP) of a vehicle and a method of its use. The invention also relates to a retainer structure for holding a vehicle upon any vehicle testing platform.

### CROSS-REFERENCE TO RELATED APPLICATIONS

The present invention is a continuation in part of U.S. patent application Ser. No. 12/731,157, filed on Mar. 25, 2010, herein incorporated in its entirety by reference.

### FIELD OF THE INVENTION

The invention generally pertains to vehicle characteristic testing (VCT) and other chassis dynamometers. More specifically, the invention relates to a tester apparatus and method for testing of the Electronic Stability Program (ESP) in vehicles containing an ESP. The invention additionally relates to a retainer structure for holding a vehicle upon a testing platform and prevention of shifting of the vehicle during testing.

### BACKGROUND OF THE INVENTION

Modern vehicles are high-performance machines. Yet, in many cases the testing system used to determine their annual roadworthiness is inadequate. Conventional vehicle testing systems operate according to inappropriate specifications. Vehicle testing methods were developed years ago and have not been adapted to modern high-performance, high-speed vehicles.

Four-wheel-drives have a greater propensity to roll over than conventional sedans, and their drivers are more likely to be killed in a roll. High speeds and the higher center of gravity also raise the likelihood of roll-overs.

Because of this danger, many four-wheel-drive vehicles are now equipped with an Electronic Stability Program (ESP), which is an automatic braking system that can brake a car's wheels individually during a slide to help a driver regain control. The ESP measures left-right movement and directional consistency between the front wheels.

However, testing of the efficiency of the ESP of a vehicle, which may become faulty over time, is yet unknown, and not included in a yearly test typically performed for ensuring functionality of vehicles in use.

Typical testing of a vehicle includes use of a chassis dynamometer present in a vehicle testing platform, typically VCT. A dynamometer measures force, moment of force (torque) or power. For example, the power produced by a motor can be calculated by simultaneously measuring torque and rotational speed. A mass acceleration dynamometer can testing the absolute power output of motors. In a sweep test the engine is tested under a load (inertia or brake loading) but allowed to “sweep” up continuously in rotational speed from a specified lower “starting” rpm to a specified “end” rpm.

Those skilled in the art may contend that movement of a vehicle during testing cannot be effectively prevented. Occasionally, a vehicle will unintentionally shift during testing, and fall off the tester platform, as the wheels are spun by the chassis dynamometer or by other testing means. This results in damage to the vehicle and to surrounding structures, and represents a danger of bodily harm to anyone in the vicinity of the runaway vehicle.

Additionally, there is no known way to test the ESP, either on the road or at a testing station.

It is an object of the invention to provide a retainer structure for inclusion in a vehicle testing and evaluation platform for prevention of excessive movement of a vehicle undergoing testing. Additionally the structure may be utilized to test whether the ESP of a vehicle is in working order.

This and other objects of the invention will become more apparent in the detailed description of the invention that follows.

### SUMMARY OF THE INVENTION

In the present invention, the term “principal wheels” refers to wheels controlled by braking or steering elements. Such wheels are included in testing of the ESP using the vehicle testing platform of the invention. In a four wheel drive vehicle including only four wheels, this refers to all wheels. In a multi-wheeled vehicle, front wheels will typically be controlled by steering, and are therefore principal wheels, and any wheels which are controlled by braking elements are also considered principal wheels. Additional wheels may be present but are not deemed principal wheels and are therefore not included in testing of ESP.

The present invention provides a vehicle testing platform for testing the electronic stability program (ESP) of a vehicle, comprising:
at least one motor activating one or more rollers adapted to induce rotation of a vehicle wheel when said wheel is in contact with said roller; wherein a roller is present to contact and rotate each of the principal wheels of a vehicle undergoing testing;
a controller system for controlling the speed of said at least one motor, said controller system capable of ensuring unified speed of rotation for all principal wheels of a vehicle undergoing testing;
a retainer structure for retaining a vehicle undergoing testing upon a vehicle testing platform, said retainer structure attachable to the vehicle testing platform, and said retainer structure comprising retaining elements which may be positioned around the wheels of a vehicle undergoing testing;
a plurality of accelerometer sensors for contacting principal wheels of a vehicle undergoing testing; said accelerometer sensors are adapted to measure the force exerted upon a wheel of a vehicle when said wheel is brought into contact with the retaining element of said retainer structure; wherein said accelerometers are in communication with a computer which receives measurements outputted by said accelerometer sensors;
a software program uploaded on said computer, said software program adapted to compare the results of said accelerometer measurements with the force measured by the electronic stability program of a vehicle undergoing testing, and to output said comparison results, thus determining whether the electronic stability program of a vehicle effectively measures contact forces.

The invention additionally provides a method for testing the electronic stability program (ESP) of a vehicle, comprising:
rotating all principal wheels of a vehicle at a uniform speed using at least one vehicle tester motor;
turning the wheels of a vehicle to simulate a turn, using the steering system of said vehicle; said turn resulting in contacting the wheels to one or more retainer elements included in a testing platform;
measuring the impact force of said contact in (b), using a plurality of accelerometers;
comparing the measured impact force with the force measured by the electronic stability program of the vehicle undergoing testing, thus determining whether the electronic stability program of a vehicle effectively measures contact forces;
determining visually whether the wheels of said vehicle are automatically steered out of said turn, by the electronic stability program of said vehicle;
using the results of the impact force comparison and of the visual determination, to decide whether the electronic stability program of a vehicle is operative.

Moreover the invention provides a retainer structure for holding a vehicle wheel upon a vehicle testing platform, comprising:
two supporting walls which meet to form an angle, wherein said supporting walls are moveable to surround a vehicle wheel, such that the center of the wheel axis is located opposite where the supporting walls meet; wherein said supporting walls are attachable to a vehicle testing platform.

### BRIEF DESCRIPTION OF THE DRAWINGS

For a better understanding of the invention, with regard to the embodiments described, reference is made to the accompanying drawings, in which:

FIG. 1 illustrates a vehicle testing platform for testing the electronic stability program (ESP) of a vehicle. The platform includes the retainer of the invention.

FIG. 2A and FIG. 2B illustrate the retainer structures of the invention in two enlarged isometric views.

FIGS. 3-6 illustrate use of the invention to test the ESP of a four-wheel drive vehicle.

FIG. 7-8 illustrates use of the invention to test the ESP of a multi-wheel vehicle.

### DETAILED DESCRIPTION OF THE INVENTION

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The invention discloses a retainer structure which may be utilized to prevent undesirable movement of a vehicle off of any vehicle testing platform.

The retainer structure may additionally be used in conjunction with additional elements included in the vehicle testing platform of the invention, to test the functionality of the ESP of a vehicle, especially a four-wheel drive vehicle.

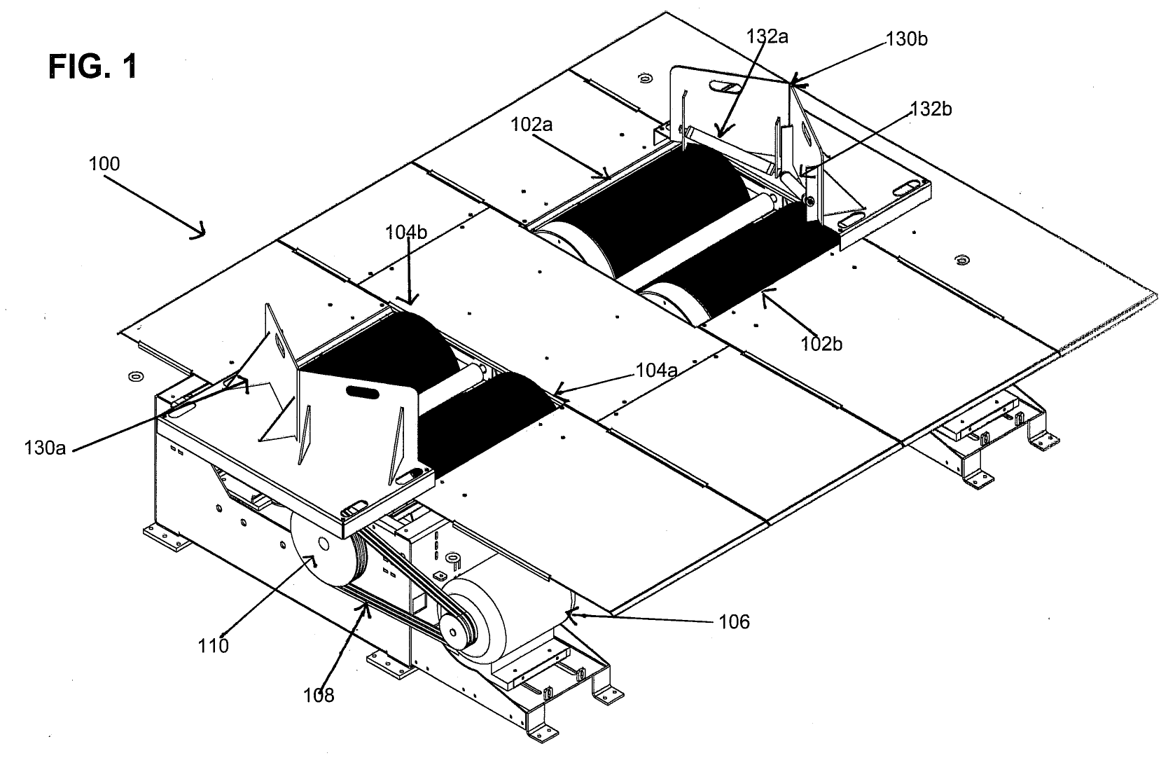

Referring to FIG. 1, vehicle testing platform 100 of the invention is shown. Rollers 102a, 102b are adapted to induce rotation of a right wheel of a vehicle, while rollers 104a, 104b induce rotation of a left wheel of a vehicle. Motor 106 revolves fan belt 108, which results in rotation of disc 110, ultimately rotating rollers 104a,b and 102a,b via additional connective propelling elements (not shown) located under platform 100.

In certain embodiments, more than one motor may be utilized to induce rotation of all wheels of a vehicle.

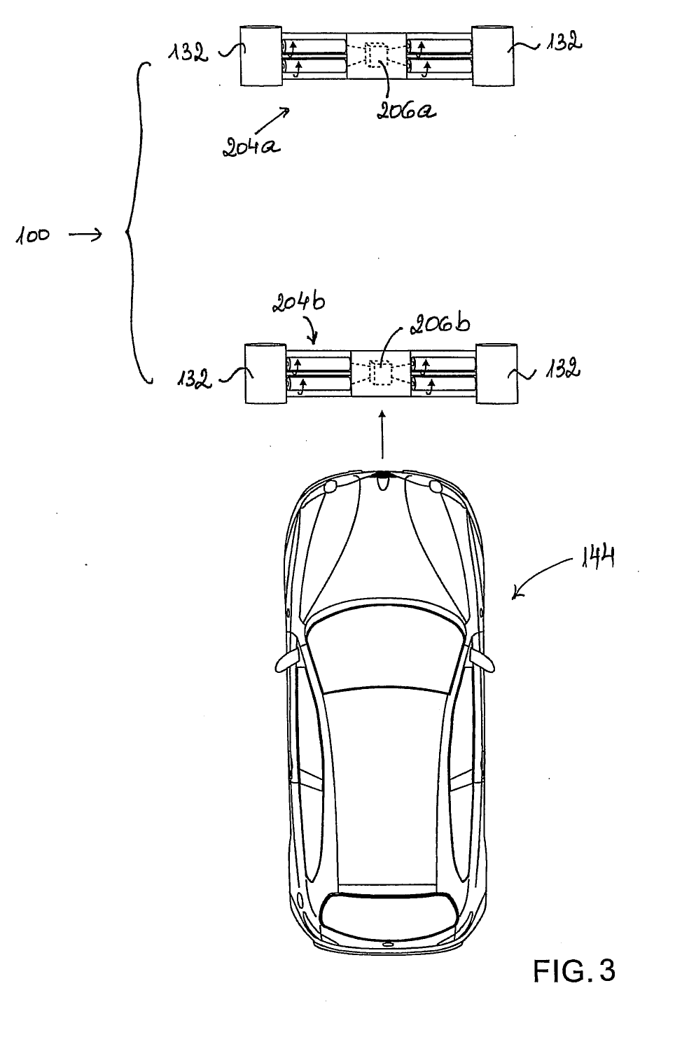

Retainer structures 130a and 130b are present external and adjacent to rollers 102a,b and 104a,b. When a vehicle is introduced onto rollers 102, 104, retainer structures 130a, b will each surround a wheel, with shafts 132a, 132b located adjacent to the outer surface of the wheel (near the hubcap). Shafts 132a, 132b and retainer structures 130a,b prevent undesirable movement of a vehicle off of a vehicle testing platform during testing. Additionally, shafts 132 and retainer structure 130 may be used to test the functionality of the ESP, as will be described herein-below in relation to FIGS. 3-8.

Retainer structure 130 and shafts 132 will now be described in greater detail.

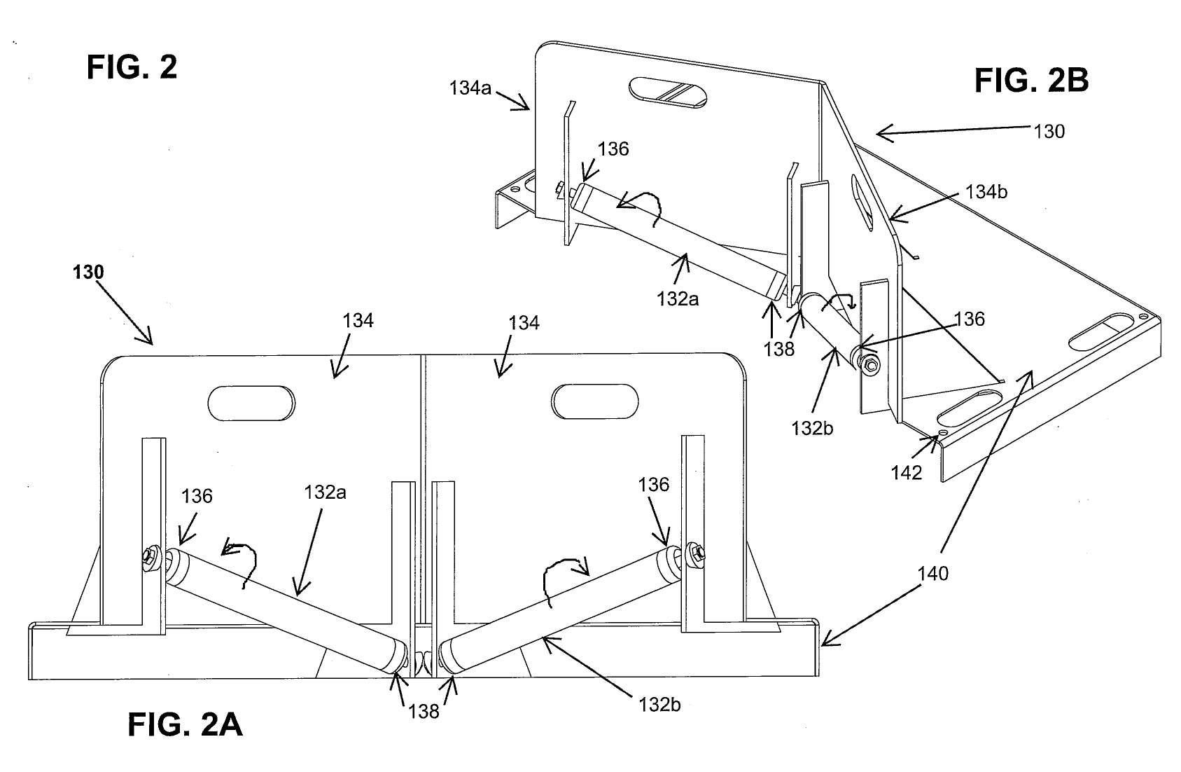

Referring to FIG. 2, retainer structures 130 are shown in two enlarged isometric views. Shafts 132 are held at their extremities upon supporting walls 134.

As best seen in FIG. 2A, shafts 132, are located on the inner side (adjacent to vehicle) of supporting walls 134. Shafts 132 are angled, to best retain a vehicle wheel within a pair of shafts 132a, 132b. An external end 136 of each shaft 132 is raised in comparison to an internal end 138 of each shaft, which is held upon the lower portion of the supporting wall 134. Shafts 132a, 132b may pivot upon their longitudinal axis, as shown by arrows, when contacted by a vehicle wheel.

As best seen in FIG. 2B, supporting walls 134a, 134b meet to form an angle within the range of 90-130°, which is optimal for retaining a vehicle wheel within.

In certain embodiments, the angle of supporting walls 134a, 134b may be adjusted prior to each use, in order to accommodate vehicle wheels of various sizes. Similarly, in some embodiments, the height of external ends 136 of the shafts 132 may be adjusted to accommodate various size vehicle wheels.

As best seen in FIG. 2B, base 140 bears supporting walls 134.

In some embodiments, retainer structures 130a, 130b are moveable upon vehicle testing platform 100, so that shafts 132 may be positioned at a distance of approximately 10-20 cm from the wheels of variously-sized vehicles. Referring to FIG. 2B, in one option, after moving the retainer structure to the appropriate distance from the vehicle wheels, pegs may be introduced through bolt holes 142 to enter appropriate rivet holes in the vehicle testing platform 100 and secure the retainer structure in place.

The retainer structure 130 of the invention may be included in any testing platform known in the art, to prevent a vehicle from advancing off a testing platform during testing.

In using the tester of the invention to test the functionality of the ESP of a four-wheel drive vehicle, all wheels of the vehicle are simultaneously rotated at a unified speed. A controller (not shown), in electronic communication with the one or more motors, is included to ensure a unified speed of rotation for all wheels.

The preferred rotation speed is within the range of 30-250 km/hr, more preferably 30-150 km/hr. The motor utilized thus outputs the equivalent of hundreds of horsepower.

In contrast, prior art chassis dynamometers typically induce rotation of a mere 5 km/hr approximately, in order to test the brakes of a vehicle, and thus prior art dynamometers would not be sufficient for use to perform the invention.

Referring to FIG. 3, use of the invention to test the ESP of a four wheel-drive vehicle will now be described. A driver advances vehicle 144 towards the testing platform until the front wheels of the vehicle rest upon front roller set 204a and the rear wheels of the four-wheel drive vehicle rest upon rear roller set 204b. The driver or testing personnel remain within the vehicle. If necessary, prior to testing, the distance between front roller set 204a and rear roller set 204b may be adjusted to suit the distance between the wheels of the particular vehicle.

After the vehicle has entered the testing platform, and the vehicle wheels rest upon roller sets 204a, 204b, shafts 132 of the retainer structure will be located opposite each wheel, preferably at a distance of approximately 10-20 cm from each wheel. The center of the wheel axis will be opposite the mid-point of the retainer structure 130, where supporting walls 134a, 134b meet.

Motor 206a is adapted to induce rotation of front roller set 204a, and second motor 206b is adapted to induce rotation of rear roller set 204b.

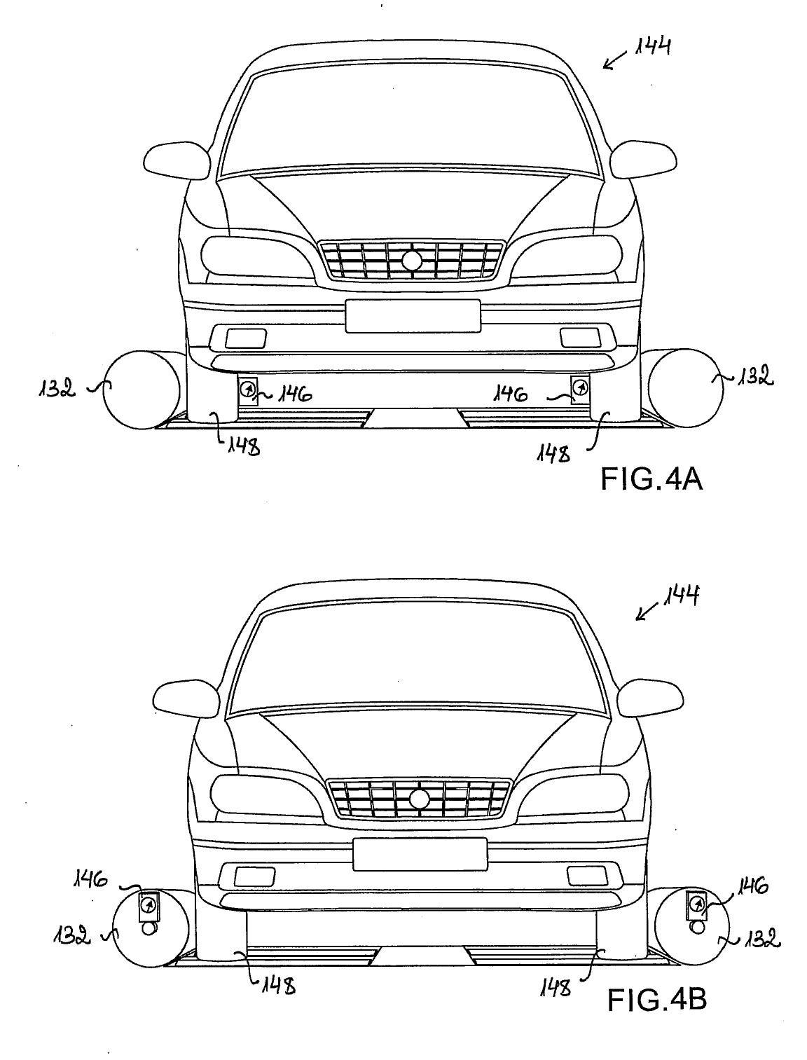

Referring now to FIG. 4A, a sensor 146 of an accelerometer is clamped onto an inner surface of each wheel 148.

Referring to FIG. 4B, alternatively, in a presently preferred embodiment, sensor 146 of the accelerometer is fixed upon shaft 132, opposite external surface of vehicle wheel 148. The accelerometer sensors are in electrical communication with the testing computer terminal and output any results measured to the testing computer.

Motors 206a and 206b are then activated to induce rotation of vehicle wheels 148. A controller (not shown), in electronic communication with the motors, is included to ensure a unified speed of rotation for all wheels.

The preferred rotation speed is within the range of 30-250 km/hr, more preferably 30-150 km/hr. (This rotation speed is far greater than achieved in prior art testers, which typically rotate wheels at approximately 5 km/hr, to test the braking system).

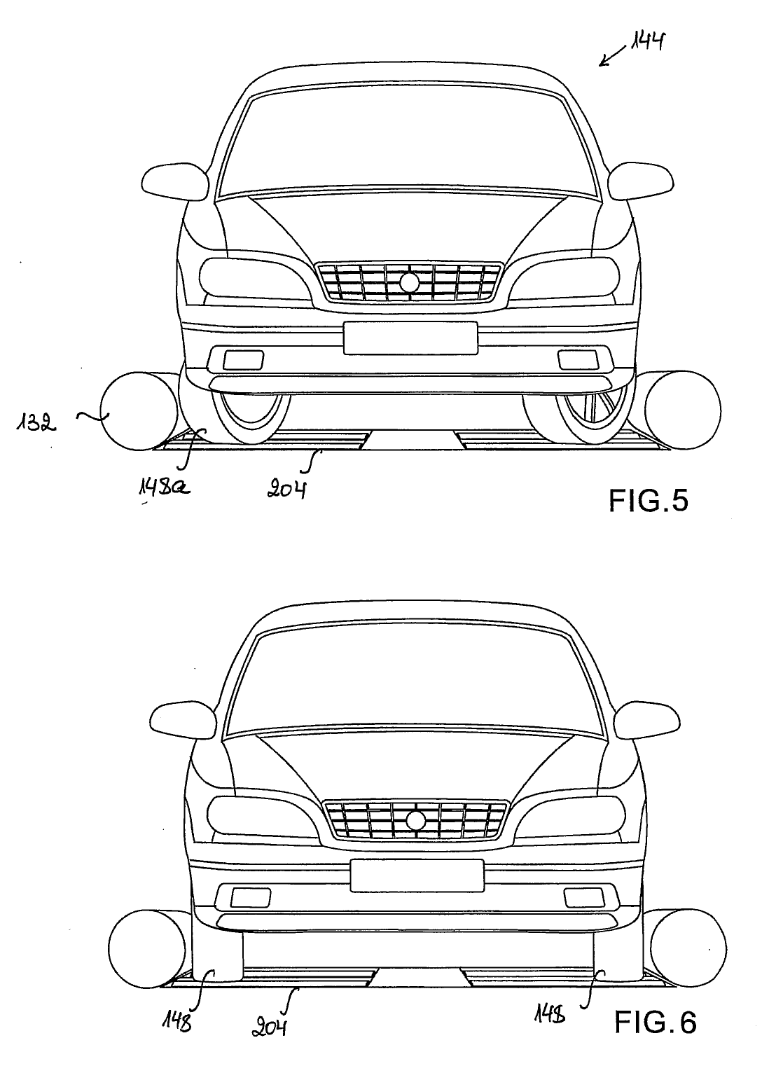

Referring to FIG. 5, the driver or testing personnel within the vehicle turns the steering wheel sharply and fully until the wheel 148a forcefully contacts the shaft 132 of the retainer structure. This simulates an uncontrolled spin or slide, which should be detected by a functioning ESP and automatically corrected for by the ESP (via ESP-controlled automatic braking).

The accelerometer sensors 146 (shown in FIGS. 4A, 4B) measure the G-force generated by the impact of the wheel with the shaft, and the results are outputted to the testing computer terminal. The software of the invention compares the G-force results measured, with those detected by the ESP of the vehicle, in order to determine that the ESP detected similar results. Failure of the ESP to detect a correct G-force measurement will result in failure of the ESP to function when a slide does indeed occur upon the road. The results of the comparison are used to reach a decision whether the ESP is functional.

While impact occurs between the vehicle wheels and the shaft, a visual inspection is done by testing personnel located outside the vehicle to observe whether, immediately after impact, the vehicle wheels are returned by action of the ESP to point straight ahead. The results of the visual inspection and of the G-force comparison are both utilized to reach a decision whether the ESP is functional.

Referring to FIG. 6, the ESP has functioned appropriately and after impact occurred, ESP overrode manual control of the vehicle, activated critical braking, and the vehicle wheels 148 have returned to point straight ahead, as shown in FIG. 6.

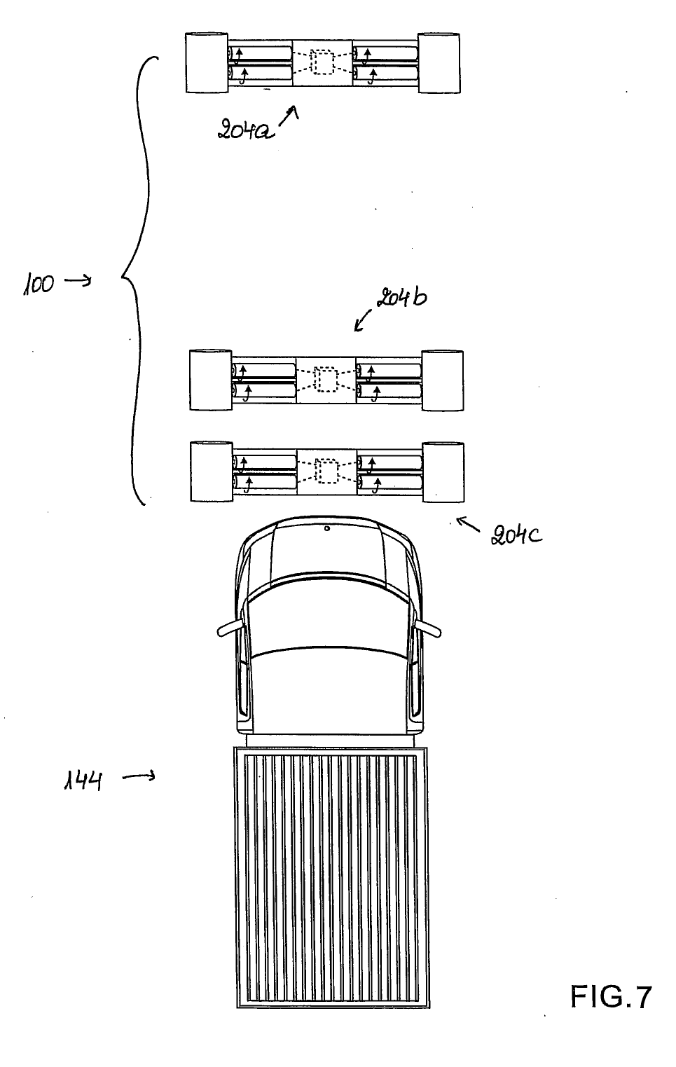

Referring to FIG. 7, the ESP of a multi-wheeled vehicle may be tested using the invention. In FIG. 7, a 6-wheeled truck 144, approaches the testing platform 100, which includes three roller sets 204a, 204b, 204c to accommodate and rotate all vehicle wheels simultaneously at a unified speed.

A multi-wheeled vehicle of any size and wheel number may be tested using the invention. In such case, for any “principal” wheels controlled by braking or steering elements, (and therefore under control of the ESP), an appropriate roller set will be included to rotate those wheels, and an accelerometer sensor to measure the impact force. Controller guarantees a unified speed of rotation for all wheels tested.

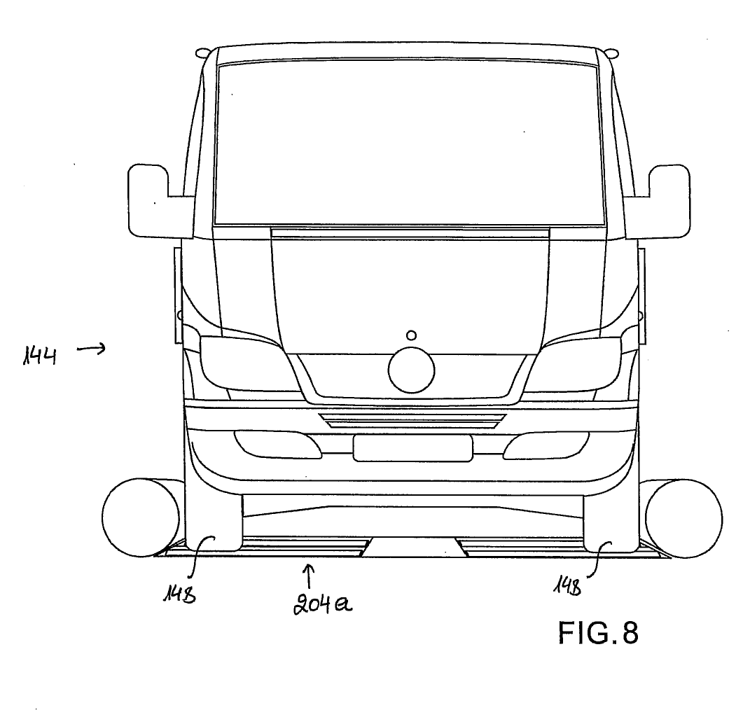

Referring to FIG. 8, the 6-wheeled vehicle 144 is shown upon the testing platform. Front wheels 148 are shown located upon front wheel roller set 204a.

Thus the testing platform of the invention along with the retainer structure may be utilized to test the functionality of the ESP of a vehicle.

The retainer structure of the invention may be utilized in conjunction with any tester platform known in the art, to prevent unwanted movement of a vehicle off of a tester platform.

It should be apparent that many modifications, substitutions, changes, and equivalents might occur to those of ordinary skill in the art.

Having described the invention with regard to certain specific embodiments thereof, it is to be understood that the description is not meant as a limitation, as further modifications will now become apparent to those skilled in the art, and it is intended to cover such modifications as are within the scope of the appended claims.

I claim:

1) A vehicle testing platform for testing the electronic stability program (ESP) of a vehicle, comprising:
a) at least one motor activating one or more rollers adapted to induce rotation of a vehicle wheel when said wheel is in contact with said roller; wherein a roller is present to contact and rotate each of the principal wheels of a vehicle undergoing testing;
b) a controller system for controlling the speed of said at least one motor, said controller system capable of ensuring unified speed of rotation for all principal wheels of a vehicle undergoing testing;
c) a retainer structure for retaining a vehicle undergoing testing upon a vehicle testing platform, said retainer structure attachable to the vehicle testing platform, and said retainer structure comprising retaining elements which may be positioned around the wheels of a vehicle undergoing testing;
d) a plurality of accelerometer sensors for contacting principal wheels of a vehicle undergoing testing; said accelerometer sensors are adapted to measure the force exerted upon a wheel of a vehicle when said wheel is brought into contact with the retaining element of said retainer structure; wherein said accelerometers are in communication with a computer which receives measurements outputted by said accelerometer sensors; and
e) a software program uploaded on said computer, said software program adapted to compare the results of said accelerometer measurements with the force measured by the electronic stability program of a vehicle undergoing testing, and to output said comparison results, thus determining whether the electronic stability program of a vehicle effectively measures contact forces.

2) The vehicle testing platform of claim 1, wherein the retaining elements comprise two supporting walls which meet to form an angle, wherein said supporting walls are moveable to surround a vehicle wheel, such that the center of the wheel axis is located opposite where the supporting walls meet; wherein said supporting walls are attachable to a vehicle testing platform.

3) The vehicle testing platform of claim 2, further comprising a pair of shafts pivotable upon their longitudinal axis, said shafts attached to the supporting walls, and said shafts extending at an angle from the horizon.

4) The vehicle testing platform of claim 1, wherein said motor is adapted to rotate the wheels of a vehicle at a speed within the range of 30-250 km/hr.

5) The vehicle testing platform of claim 1, wherein said motor is adapted to rotate the wheels of a vehicle at a speed within the range of 30-150 km/hr.

6) A method for testing the electronic stability program (ESP) of a vehicle, comprising:
a) rotating all principal wheels of a vehicle at a uniform speed using at least one vehicle tester motor;
b) turning the wheels of a vehicle to simulate a turn, using the steering system of said vehicle; said turn resulting in contacting the wheels to one or more retainer elements included in a testing platform;
c) measuring the impact force of said contact in (b), using a plurality of accelerometers;
d) comparing the measured impact force with the force measured by the electronic stability program of the vehicle undergoing testing, thus determining whether the electronic stability program of a vehicle effectively measures contact forces;
e) determining visually whether the wheels of said vehicle are automatically steered out of said turn, by the electronic stability program of said vehicle;
f) using the results of steps d) and e) to decide whether the electronic stability program of a vehicle is operative.

7) A retainer structure for holding a vehicle wheel upon a vehicle testing platform, comprising:
two supporting walls which meet to form an angle, wherein said supporting walls are moveable to surround a vehicle wheel, such that the center of the wheel axis is located opposite where the supporting walls meet; wherein said supporting walls are attachable to a vehicle testing platform.

8) The retainer structure of claim 7, further comprising a pair of shafts pivotable upon their longitudinal axis, said shafts attached to the internal side of the supporting walls, and said shafts extending at an angle from the horizon.

9) The retainer structure of claim 8, wherein the angle of said shafts and/or said supporting walls are adjustable to accommodate various size wheels.

10) The retainer structure of claim 7, wherein said retainer structure is moveable upon a vehicle testing platform to accommodate vehicles of various sizes.
